(19) United States
(12) Patent Application Publication
(10) Pub. No.: US 2011/0003555 A1
(43) Pub. Date: Jan. 6, 2011

(54) Method and Apparatus for PDCCH Monitoring

(76) Inventor: Yu-Hsuan Guo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/830,437

(22) Filed: Jul. 5, 2010

Related U.S. Application Data
(60) Provisional application No. 61/223,069, filed on Jul. 6, 2009.

(51) Int. Cl. H04B 17/00

(52) U.S. Cl. 455/67.11

(57) ABSTRACT

A method for Physical Downlink Control Channel (PDCCH) monitoring in a user equipment (UE) of a wireless communication system is disclosed. The method includes steps of activating a plurality of component carriers, detecting an uplink transmission problem, and stopping monitoring a PDCCH associated with a first component carrier of the plurality of component carriers, wherein the first component carrier is not configured for performing a Random Access procedure.

### CROSS REFERENCE TO RELATED APPLICATIONS

This application claims the benefit of U.S. Provisional Application No. 61/223069, filed on Jul. 6 , 2009 and entitled “Method and apparatus for improving Contention Based transmission and Carrier Aggregation in a wireless communication system”, the contents of which are incorporated herein by reference.

### BACKGROUND OF THE INVENTION

1. Field of the Invention

The present invention relates to a method and apparatus of Physical Downlink Control Channel (PDCCH) monitoring, and more particularly, to a method and apparatus for performing PDCCH monitoring in an user equipment (UE) of a wireless communication system, so as to reduce power consumption of the UE.

2. Description of the Prior Art

Long Term Evolution (LTE) wireless communication system, an advanced high-speed wireless communication system established upon the 3G mobile telecommunication system, supports only packet-switched transmission, and tends to implement both Medium Access Control (MAC) layer and Radio Link Control (RLC) layer in one single communication site, such as in base stations (Node Bs) alone rather than in Node Bs and RNC (Radio Network Controller) respectively, so that the system structure becomes simple.

In LTE system, based on 3GPP technical specification TS 36.321 V8.6.0, a user equipment (UE) needs to be synchronized with a serving base station, i.e. the serving Node B, on uplink timing to prevent signals transmitted from the UE from colliding with those sent from other UEs under the coverage of the base station. A Time Alignment Timer of the UE is utilized for indicating whether the UE is synchronized with the base station on uplink timing. When the Time Alignment timer is running, uplink timing is considered synchronized. If the Time Alignment timer expires, then this indicates that the UE no longer has uplink synchronization with the base station. Besides, a Timing Advance Command is transmitted by the base station to update a Timing Advance value of the UE for maintenance of uplink time alignment. Definition of the Timing Advance value can be referred in related specifications, and is not given herein.

In general, if the UE has established connection with the base station, the Timing Advance Command is carried in a Timing Advance MAC Control Element for transmission. Otherwise, the Timing Advance Command is transmitted through a Random Access Response message of a Random Access procedure. In addition, whenever the Timing Advance value is updated, the UE shall start or restart the Time Alignment timer.

Upon expiry of the Time Alignment timer, the UE shall: (1) flush all Hybrid Automatic Repeat reQuest (HARQ) buffers; (2) notify Radio Resource Control (RRC) layer to release Physical Uplink Control Channel (PUCCH) resource and Sounding Reference Signal (SRS) resource; and (3) clear any configured downlink assignments and uplink grants, e.g. Semi-Persistent Scheduling (SPS) resource. Thus, when the Time Alignment timer expires or is not running, the UE is prohibited using any uplink resource configured for the UE to perform uplink transmission. Under this situation, even if downlink transmission is received, the corresponding HARQ feedback, i.e. ACK or NACK, cannot be transmitted.

Besides, when the Time Alignment timer is not running or has expired, prior to any uplink transmission, the UE shall use the Random Access Procedure to obtain Timing Advance information in order to obtain uplink time alignment. This indicates the UE should not perform any uplink transmission when the uplink timing of the UE is not synchronized with the base station. The Random Access Procedure may be triggered due to the following two cases: (1) when the UE has new uplink data to transmit and triggers a Regular Buffer Status Reporting (BSR); (2) when a Physical Downlink Control Channel (PDCCH) order indicating the UE to perform the Random Access Procedure is received, which are summarized in the below, respectively.

(1) The UE releases all uplink transmission resources when the Time Alignment timer expires. Thus, there is no available uplink grant for the triggered BSR. Then, the UE triggers a Scheduling Request (SR) to request allocation of uplink grant. However, all configured PUCCH resource is also released. Thus, the UE further triggers a Random Access Procedure for requesting uplink grant.

(2) The UE can still receive downlink transmission when the Time Alignment timer expires. Thus, in order to make the UE able to transmit the HARQ feedback, e.g. ACK or NACK, the network would send a PDCCH order to request the UE to perform the Random Access Procedure, so that the UE can obtain the Timing Advance Command to resume uplink synchronization and perform uplink transmission.

In the LTE system, except expiry of the Time Alignment timer, the UE may also determine occurrence of an uplink transmission problem such as the PUCCH resources for sending SR are invalid (which is probably due to poor signal quality or improper power settings), for example, when the transmission times of SR exceeds a pre-defined value and still not succeed.

According to the current specifications, a counter SR_COUNTER counts the transmission times of SR in the SR procedure, while a pre-defined parameter dsr-TransMax indicates an upper limit of the SR transmission times. When the transmission times of SR reaches to the pre-defined parameter dsr-TransMax, it indicates uplink transmission of the UE may have some problem, and the UE shall (1) notify RRC layer to release PUCCH and SRS resources; (2) clear configured downlink assignments and uplink grants; and (3) initiate a Random Access procedure and cancel all pending SR(s).

Thus, in the LTE system, the UE may detect an uplink transmission problem upon expiry of the Time Alignment timer or when the transmission times of SR exceeds the pre-defined value. In such a situation, the UE shall perform a Random Access procedure to obtain the Timing Advance value and (or) uplink resources, so as to recover the uplink transmission. As mentioned above, due to downlink transmission requirements, the network may request the UE to initiate a Random. Access Procedure via PDCCH order. Thus, the UE still needs to monitor PDCCH even when the uplink transmission problem occurs.

However, the 3GPP has started to work out a next generation of the LTE system: the LTE Advanced (LTE-A) system, to meet future requirements of all kinds of communication services. Carrier aggregation, where two or more component carriers (CCs) are aggregated, is introduced into the LTE-A system in order to support wider transmission bandwidths, e.g. up to 100 MHz and for spectrum aggregation. A UE of the LTE-A system utilizes multiple component carriers instead of a single component carrier used in the former LTE system, to establish multiple links for receiving or transmitting on each component carrier.

Carrier aggregation related agreements can be captured in the 3GPP meeting document R2-093694. It has been agreed that a common Timing Advance value is used on all CCs, and that at most one Random Access procedure shall be ongoing at any time.

Therefore, in the LTE-A system, the UE that supports carrier aggregation may use multiple component carriers at the same time. Accordingly, when the UE detects an uplink transmission problem, the UE shall monitor all PDCCHs associated with all activated CCs, to detect whether there is any PDCCH order indicating the UE to perform the Random Access procedure. However, since the network should not allocate uplink transmission resource or perform downlink transmission when some uplink transmission problem occurs, and the UE can only perform one Random Access procedure at the same time, monitoring all PDCCHs associated with all component carriers may result in unnecessary UE power consumption.

On the other hand, in order to reduce the UE power consumption in LTE system, Discontinuous Reception (DRX) functionality is applied in MAC layer for allowing the UE to enter a standby mode during certain periods of time and stopping monitoring PDCCH.

When the DRX functionality is configured, the UE is allowed to stop monitoring the PDCCH during some period of time. The situations that the UE monitors the PDCCH when the DRX functionality is configured are summarized as follows: (1) when an On Duration Timer is running; (2) when a DRX Inactivity Timer is running; and (3) when a DRX Retransmission Timer is running. It is noted that in the DRX functionality, the period of time that the UE needs to monitor PDCCH is named “active time”. Detailed operations of the DRX functionality can be referred to related specifications, and are not further narrated herein.

In the LTE-A system, DRX operation for carrier aggregation is discussed and captured in the 3GPP meeting document R2-093914. There are three alternatives for DRX configuration of Component Carriers:
(1) Same DRX configuration applies to all component carriers;
(2) DRX is configured independently for each of the component carriers; and
(3) One DRX configuration applies only to one (anchor) component carrier. DRX operations of other component carriers are activated by the eNodeB by explicit or implicit triggers and rules.

Assume the option (1) or (2) is chosen or the DRX functionality is not enabled. The UE needs to monitor multiple PDCCHs for different CCs in the same or different transmission time interval (TTI), to detect downlink assignment or uplink grant. Similarly, since the network should not allocate uplink transmission resource or perform downlink transmission when some uplink transmission problem occurs, and the UE can only perform one Random Access procedure at the same time, monitoring all PDCCHs associated with all activated component carriers when the UE detects some uplink transmission problem such as upon expiry of the Time Alignment timer or when the transmission times of SR exceeds the pre-defined value, for example, may result in unnecessary UE power consumption.

### SUMMARY OF THE INVENTION

It is therefore an objective of the present invention to provide a method and apparatus for handling PDCCH monitoring in an UE of a wireless communication system.

According to the present invention, a method for PDCCH monitoring in an UE of a wireless communication system is disclosed. The wireless communication system supports Carrier Aggregation (CA) such that the UE is able to perform transmission and/or reception through multiple carriers. The method includes steps of activating a plurality of component carriers; detecting an uplink transmission problem; and stopping monitoring a PDCCH associated with a first component carrier of the plurality of component carriers, wherein the first component carrier is a component carrier not configured for performing a Random Access procedure.

According to the present invention, a communications device for PDCCH monitoring in an UE of a wireless communication system is disclosed. The wireless communication system supports Carrier Aggregation (CA) such that the UE is able to perform transmission and/or reception through multiple carriers. The communications device includes a processor for executing a program, and a memory, coupled to the processor, for storing the program. The program includes steps of activating a plurality of component carriers; detecting an uplink transmission problem; and stopping monitoring a PDCCH associated with a first component carrier of the plurality of component carriers, wherein the first component carrier is a component carrier not configured for performing a Random Access procedure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system.

FIG. 2 is a function block diagram of a wireless communications device.

FIG. 3 is a diagram of program code of FIG. 2.

FIG. 4 is a flowchart of a process according to an embodiment of the present invention.

### DETAILED DESCRIPTION

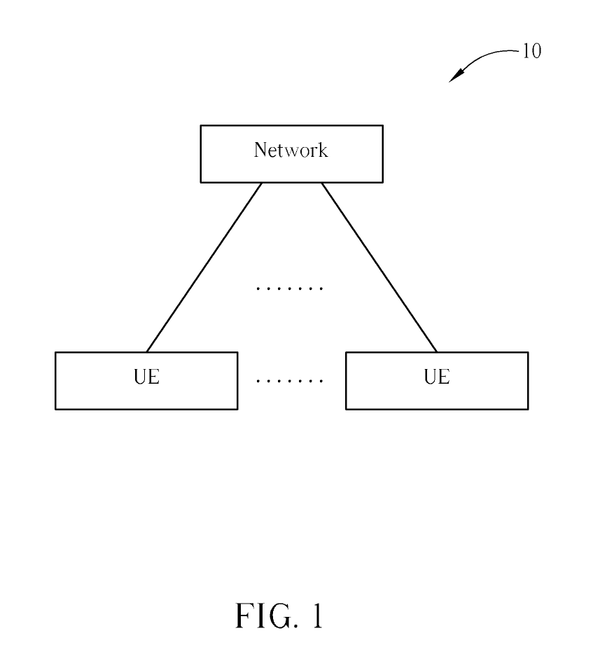

Please refer to FIG. 1, which illustrates a schematic diagram of a wireless communications system 10. The wireless communications system 10 is preferred to be a Long Term Evolution (LTE) wireless communication system, and is briefly composed of a network and a plurality of user equipments (UEs). In FIG. 1, the network and the UEs are simply utilized for illustrating the structure of the wireless communications system 10. Practically, the network may comprise a plurality of base stations (Node Bs), radio network controllers and so on according to actual demands, and the UEs can be devices such as mobile phones, computer systems, etc.

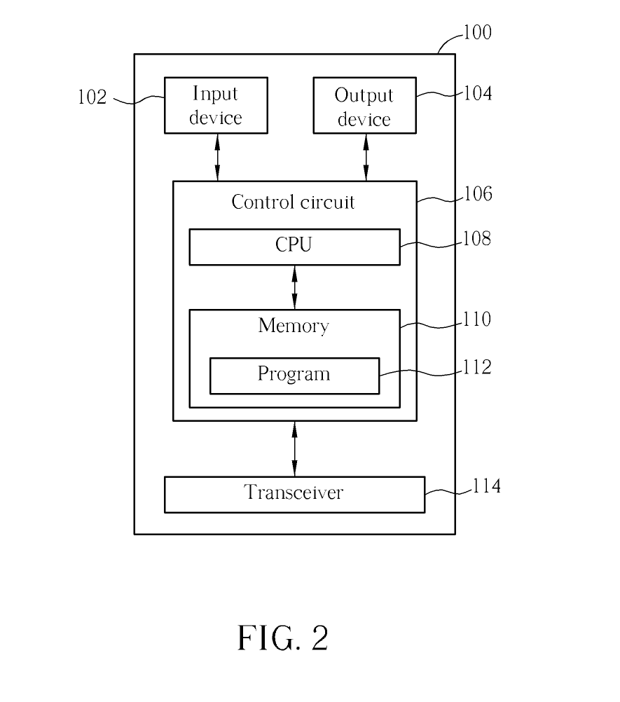

Please refer to FIG. 2, which is a functional block diagram of a communications device 100 in a wireless communications system. The communications device 100 can be utilized for realizing the UEs or the network in FIG. 1. For the sake of brevity, FIG. 2 only shows an input device 102, an output device 104, a control circuit 106, a central processing unit (CPU) 108, a memory 110, a program 112, and a transceiver unit 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver unit 114 is used to receive and transmit wireless signals, delivering received signals to the control circuit 106, and outputting signals generated by the control circuit 106 wirelessly. From a perspective of a communications protocol framework, the transceiver unit 114 can be seen as a portion of Layer 1, and the control circuit 106 can be utilized to realize functions of Layer 2 and Layer 3.

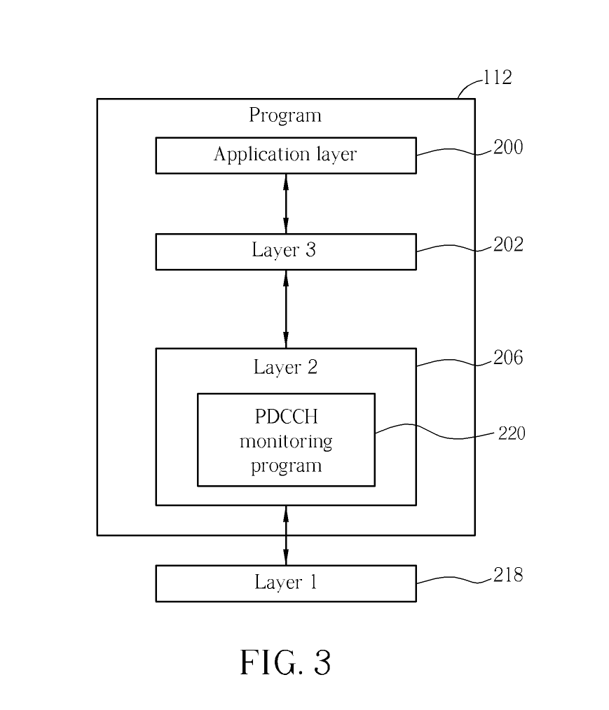

Please continue to refer to FIG. 3. FIG. 3 is a diagram of the program 112 shown in FIG. 2. The program 112 includes an application layer 200, a Layer 3 202, and a Layer 2 206, and is coupled to a Layer 1 218. The Layer 3 202 performs radio resource control. The Layer 2 206 comprises a Radio Link Control (RLC) layer and a Medium Access Control (MAC) layer, and performs link control. The Layer 1 218 performs physical connections.

In the LTE-A system, the program 112 supports Carrier Aggregation technology, by which the UE is able to perform data transfer simultaneously on multiple network-configured component carriers. When the UE of the LTE-A system detects an uplink transmission problem such as upon expiry of a Time Alignment timer or when the transmission times of scheduling Request (SR) exceeds a pre-defined value, for example, based on operations of the LTE system, the UE shall monitor all PDCCHs associated with all activated competent carriers (CCs), to detect whether there are PDCCH orders indicating the UE to perform a Random Access procedure. However, since the network should not allocate uplink resources or perform downlink transmission when some uplink transmission problem occurs, and not all configured CCs would be used to perform the Random Access procedure under carrier aggregation, monitoring all PDCCHs associated with all CCs may result in unnecessary UE power consumption.

In such a situation, the embodiment of the present invention provides a PDCCH monitoring program 220 in the program 112, for improving the way the UE monitors PDCCHs associated with component carriers when detecting some uplink transmission problems, so as to avoid unnecessary UE power consumption.

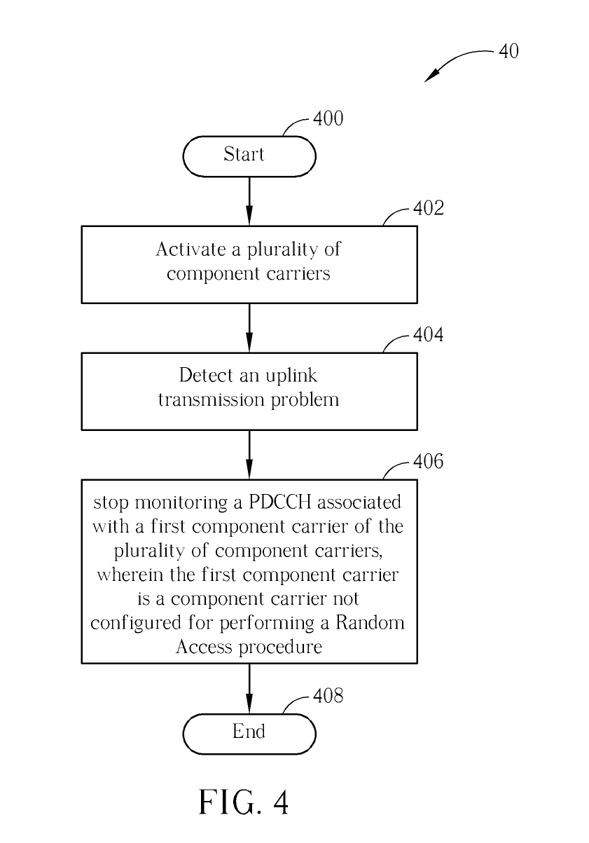

Please refer to FIG. 4, which illustrates a schematic diagram of a process 40. The process 40 is utilized for performing PDCCH monitoring in an UE of the wireless communications system 10, and can be compiled into the PDCCH monitoring program 220. The process 40 includes the following steps:

Step 400: Start.

Step 402: Activate a plurality of component carriers.

Step 404: Detect an uplink transmission problem.

Step 406: Stop monitoring a PDCCH associated with a first component carrier of the plurality of component carriers, wherein the first component carrier is a component carrier not configured for performing a Random Access procedure.

Step 408: End.

According to the process 40, when the carrier aggregation is activated and the UE detect some uplink transmission problem such as upon expiry of the Time Alignment timer or when the transmission times of SR exceeds a pre-defined value, for example, the UE shall stop monitoring the PDCCH associated with the first component carrier of the plurality of component carriers. The first component carrier is an activated component carrier not configured for performing a Random Access procedure.

As motioned in the prior art, when some uplink transmission problem is detected, the UE shall perform a Random Access procedure to obtain a Timing Advance value and (or) uplink resources, so as to recover the uplink transmission. However, due to downlink transmission requirements, the network may request the UE to initiate a Random Access Procedure via PDCCH order. Thus, the UE still needs to monitor PDCCH even when the uplink transmission problem occurs.

However, not all configured component carriers would be used for performing the Random Access procedure under carrier aggregation. Thus, according to the process 40, the UE only monitors one or few PDCCHs that are associated with the component carriers configured for performing the Random Access procedure. As a result, the embodiment of the present invention can prevent the UE from performing unnecessary PDCCH monitoring, so as to save power consumption.

There are at least two component carriers configured for performing the Random Access procedure. One is an uplink component carrier, and the other is a downlink component carrier. In general, the component carriers configured for performing the Random Access procedure is corresponding to a serving cell that the UE resides in, but are not restricted to this.

Besides, when the uplink transmission problem is determined recovered such as the Time Alignment timer starts again, the UE shall resume monitoring the PDCCH associated with the first component carrier. Or, when the UE successfully completes a Random Access procedure, at that time the uplink transmission problem is also considered recovered since the UE obtains a Timing Advance value and (or) uplink resources, the UE shall also resume monitoring the PDCCH associated with the first component carrier.

In the embodiment of the present invention, the way to stop monitoring the PDCCH associated with the first component carrier can be though deactivating the first component carrier, but is not limited to this.

For example, assume the UE supports Discontinuous Reception (DRX) functionality for reducing the power consumption, if the said option (1) or (2) for CA DRX is chosen, i.e. all component carriers are configured with a same DRX configuration, or each of the component carriers are configured with a DRX configuration independently, the UE needs to monitor multiple PDCCHs for different CCs in the same or different transmission time interval (TTI), to detect downlink assignment or uplink grant.

In such a situation, the way to stop monitoring the PDCCH associated with the first component carrier can be through prohibiting the DRX functionality associated with the first component carrier from entering Active Time; prohibiting the DRX functionality associated with the first component carrier from starting an On Duration Timer; or stopping all DRX timers associated with the first component carrier, but are not limited to these.

It is worth noting that the component carrier not configured for performing the Random Access procedure means no Random Access Response message of the Random Access procedure will be received on the component carrier, or means no Contention Resolution message of the Random Access procedure will be received on the component carrier; or further means no PDCCH orders that indicates initiation of the Random Access procedure will be received on the component carrier.

In addition, the component carriers activated in the UE side may include uplink components carriers and/or downlink component carriers, wherein activating the component carriers means to perform downlink reception and/or uplink transmission on those component carriers. The above definitions and operations are well known by those skilled in the art, and thus are not further described herein.

In summary, when the uplink transmission problem is detected, the UE according to the embodiment of the present invention stops monitoring the PDCCHs associated with CCs not configured for performing the Random Access procedure, so that unnecessary power consumption can be avoided by the UE.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for Physical Downlink Control Channel (PDCCH) monitoring in an user equipment (UE) of a wireless communication system, the wireless communication system supporting Carrier Aggregation (CA) such that the UE is able to perform transmission and/or reception through multiple carriers, the method comprising:
activating a plurality of component carriers;
detecting an uplink transmission problem; and
stopping monitoring a PDCCH associated with a first component carrier of the plurality of component carriers, wherein the first component carrier is a component carrier not configured for performing a Random Access procedure.

2. The method of claim 1, wherein the uplink transmission problem is detected upon expiry of a Time Alignment timer.

3. The method of claim 1, wherein the uplink transmission problem is detected when the transmission times of a Scheduling Request (SR) exceeds a pre-defined value.

4. The method of claim 1 further comprising:
monitoring a PDCCH associated with a second component carrier of the plurality of component carriers.

5. The method of claim 4, wherein the second component carrier is for a serving cell.

6. The method of claim 1 further comprising:
resuming monitoring the PDCCH associated with the first component carrier when the uplink transmission problem is recovered.

7. The method of claim 1 further comprising:
resuming monitoring the PDCCH associated with the first component carrier when the UE successfully completes a Random Access procedure.

8. The method of claim 1, wherein stopping monitoring the PDCCH associated with the first component carrier is to deactivate the first component carrier.

9. The method of claim 1, wherein the plurality of component carriers are configured with Discontinuous Reception (DRX) functionality.

10. The method of claim 9, wherein stopping monitoring the PDCCH associated with the first component carrier is to prohibit the DRX functionality associated with the first component carrier from entering Active Time.

11. The method of claim 9, wherein stopping monitoring the PDCCH associated with the first component carrier is to prohibit the DRX functionality associated with the first component carrier from starting an On Duration Timer.

12. The method of claim 9, wherein stopping monitoring the PDCCH associated with the first component carrier is to stop all DRX timers associated with the first component carrier.

13. The method of claim 9, wherein the plurality of component carriers are configured with a same DRX configuration.

14. The method of claim 9, wherein each of the plurality of component carriers are configured with a DRX configuration independently.

15. The method of claim 1, wherein the component carrier not configured for performing the Random Access procedure means no Random Access Response message of the Random Access procedure is received on the component carrier.

16. The method of claim 1, wherein the component carrier not configured for performing the Random Access procedure means no Contention Resolution message of the Random Access procedure is received on the component carrier.

17. The method of claim 1, wherein the component carrier not configured for performing the Random Access procedure means no PDCCH orders that indicates initiation of the Random Access procedure are received on the component carrier.

18. The method of claim 1, wherein the plurality of component carriers comprises uplink components carriers and/or downlink component carriers.

19. The method of claim 1, wherein activating the plurality of component carriers is to perform downlink reception and/or uplink transmission on the plurality of component carriers.

20. A communication device for Physical Downlink Control Channel (PDCCH) monitoring in an user equipment (UE) of a wireless communication system, the wireless communication system supporting Carrier Aggregation (CA) such that the UE is able to perform transmission and/or reception through multiple carriers, the communication device comprising:
a processor for executing a program; and
a memory coupled to the processor for storing the program; wherein the program comprises:
activating a plurality of component carriers;
detecting an uplink transmission problem; and
stopping monitoring a PDCCH associated with a first component carrier of the plurality of component carriers, wherein the first component carrier is a component carrier not configured for performing a Random Access procedure.

21. The communication device of claim 20, wherein the uplink transmission problem is detected upon expiry of a Time Alignment timer.

22. The communication device of claim 20, wherein the uplink transmission problem is detected when the transmission times of a Scheduling Request (SR) exceeds a pre-defined value.

23. The communication device of claim 20, wherein the program further comprises:
monitoring a PDCCH associated with a second component carrier of the plurality of component carriers.

24. The communication device of claim 23, wherein the second component carrier is for a serving cell.

25. The communication device of claim 20, wherein the program further comprises:
resuming monitoring the PDCCH associated with the first component carrier when the uplink transmission problem is recovered.

26. The communication device of claim 20, wherein the program further comprises:
resuming monitoring the PDCCH associated with the first component carrier when the UE successfully completes a Random Access procedure.

27. The communication device of claim 20, wherein stopping monitoring the PDCCH associated with the first component carrier is to deactivate the first component carrier.

28. The communication device of claim 20, wherein the plurality of component carriers are configured with Discontinuous Reception (DRX) functionality.

29. The communication device of claim 28, wherein stopping monitoring the PDCCH associated with the first component carrier is to prohibit the DRX functionality associated with the first component carrier from entering Active Time.

30. The communication device of claim 28, wherein stopping monitoring the PDCCH associated with the first component carrier is to prohibit the DRX functionality associated with the first component carrier from starting an On Duration Timer.

31. The communication device of claim 28, wherein stopping monitoring the PDCCH associated with the first component carrier is to stop all DRX timers associated with the first component carrier.

32. The communication device of claim 28, wherein the plurality of component carriers are configured with a same DRX configuration.

33. The communication device of claim 28, wherein each of the plurality of component carriers are configured with a DRX configuration independently.

34. The communication device of claim 20, wherein the component carrier not configured for performing the Random Access procedure means no Random Access Response message of the Random Access procedure is received on the component carrier.

35. The communication device of claim 20, wherein the component carrier not configured for performing the Random Access procedure means no Contention Resolution message of the Random Access procedure is received on the component carrier.

36. The communication device of claim 20, wherein the component carrier not configured for performing the Random Access procedure means no PDCCH orders that indicates initiation of the Random Access procedure are received on the component carrier.

37. The communication device of claim 20, wherein the plurality of component carriers comprises uplink components carriers and/or downlink component carriers.

38. The communication device of claim 20, wherein activating the plurality of component carriers is to perform downlink reception and/or uplink transmission on the plurality of component carriers.
